(19) United States
(12) Patent Application Publication
(10) Pub. No.: US 2010/0134424 A1
(43) Pub. Date: Jun. 3, 2010

(54) EDGE HAND AND FINGER PRESENCE AND MOTION SENSOR

(75) Inventors: ARTHUR BRISEBOIS, CUMMING, GA (US); ROBERT S. KLEIN, MANCHESTER, CT (US)

Correspondence Address: AT&T Legal Department - T&W;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/326,193

(22) Filed: Dec. 2, 2008

(51) Int. Cl. G06F 3/041

(52) U.S. Cl. 345/173

(57) ABSTRACT

Systems and methodologies for controlling an electronic device are provided herein. As described herein, sensors (e.g. capacitive, resistive, touch-sensitive, etc.) are applied to respective outer edges of a device to detect presence and/or motion of a user's fingers and/or hands, thereby leveraging the outer edges of the device as an input mechanism. For example, points along an edge sensor can be mapped to soft keys to enable inferred hand and finger locations to be utilized for device input. Further, characteristics of a user's hands and/or fingers can be discovered over time and/or learned based on an initial calibration procedure, and these characteristics can subsequently be utilized to adjust sensor operation for optimal accuracy and user comfort. In addition, selected device features can be secured by utilizing an identifying set of sensor contacts from a user as a passcode that requires duplication before the selected device features can be accessed.

### TECHNICAL FIELD

The following disclosure relates generally to portable electronic devices, and more particularly to techniques for providing input to a portable electronic device.

### BACKGROUND

As handheld electronic devices, such as mobile telephone handsets, electronic game controllers, and the like, increase in prevalence and increase in processing power, applications for such devices are becoming more sophisticated. In addition, in order to support the increasing sophistication of handheld device applications, such devices are being designed to utilize larger display areas. As tile display size of a handheld device increases, the amount of space on the device for fixed mechanical buttons and controls decreases. Further, at portions of a handheld device where space for mechanical controls does exist, such controls often lack sufficient flexibility and granularity to suit various hand sizes and positions and/or to support complex applications.

Touch-screens are conventionally utilized for providing input to size-constrained devices as a result of the above-noted limitations of mechanical controls. However, touch-screens and similar input mechanisms utilize a large amount of power for lighting. Further, such input mechanisms for handheld devices are not oriented in the most natural or convenient positions for the users manipulating them or for the applications that utilize them. Accordingly, it would be desirable to implement input mechanisms for handheld devices that mitigate at least the above shortcomings.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methodologies are provided herein that facilitate improved input functionality for a handheld electronic device. In accordance with various aspects described herein, sensors can be applied to one or more outer edges of a device that can detect presence and/or motion of a user's fingers and/or hands with respect to the edges of the device. By monitoring the positioning and movement of a user's hands along the edges of a device, various aspects described herein enable the outer edges of a handheld device as an additional input source for various touch- and movement-specific functions and applications running on the device. Benefits of this implementation include reduced power consumption as compared to conventional input mechanisms for handheld devices, improved flexibility for supporting a variety of user inputs over a smaller amount of device space, and a more natural and comfortable input experience for size-constrained devices.

In accordance with one aspect, sensors (e.g., capacitive sensors, resistive sensors, pressure sensors, etc.) can be placed along one or more side and/or back edges of a device to perform various measurements relating to contact between a user and the device edges at which the sensors are placed. For example, the sensors can be utilized to detect and report the presence or absence of skin contact at various points along the edges of a handheld device. Further, the sensors can monitor parameters such as the presence, location, width, spacing, count, pressure, and/or movement of such contact points to infer the presence and location of a user's hands and/or fingers along the edges of a device. In one example, information relating to the presence and/or positioning of a user's fingers and/or hands can be utilized to provide input to an associated device by, for example, mapping various points along respective sensors to a set of soft keys.

In accordance with another aspect, a device employing edge sensors as described herein can prompt a user to position his hands and/or fingers in a variety of manners (e.g., of varying location, pressure, movement, etc.) along the sensors. As the user performs the prompted actions, the sensors can obtain information relating to characteristics of the user's hands and/or fingers, based on which the operation of the sensors can be calibrated. In a specific example, a calibration procedure performed as described herein can be utilized to detect that a user is missing one or more fingers and/or is otherwise physically disabled, based on which the device can be configured to accommodate the physical ability of the user.

In accordance with an additional aspect described herein, a device can employ edge sensors as described herein to secure one or more applications and/or features of an associated device. For example, for one or more secured features of a handheld device, a user can provide an identifying set of contacts along the edge sensors of the device. Subsequently, the set of contacts can be utilized in a similar manner to a passcode in order to condition access to various secured features of the device on successful duplication of the contacts. For example, a device can be configured such that an identifying set of contacts is provided as a user holds the device to access a feature of the device. Subsequently, later access to the feature can be denied unless the device is held in substantially the same manner as the initial access.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system for controlling a handheld device in accordance with various aspects.

FIG. 2 illustrates an example sensor implementation for an electronic device in accordance with various aspects.

FIG. 3 is a block diagram of a system for controlling a handheld device in accordance with various aspects.

FIGS. 4-5 illustrate example implementations of an edge sensor in accordance with various aspects.

FIG. 6 is a block diagram of a system for processing sensor contacts in accordance with various aspects.

FIG. 7 illustrates example measurements relating to sensor contacts that can be performed in accordance with various aspects.

FIG. 8 is a block diagram for associating a soft key mapping with a sensor in accordance with various aspects.

FIG. 9 is a block diagram of a system for sensor calibration in accordance with various aspects.

FIG. 10 is a block diagram of a system for securing a portable device in accordance with various aspects.

FIGS. 11-12 are flowcharts of respective methods for controlling an electronic device.

FIG. 13 is a flowchart of a method for calibrating a touch sensing system.

FIG. 14 is a flowchart of a method for utilizing an edge sensor to secure a handheld electronic device.

FIG. 15 is a block diagram of a computing system in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, it is to be appreciated that while various drawings are provided herein to illustrate respective example embodiments of the claimed subject matter, the embodiments illustrated herein are not necessarily to be construed as preferred or advantageous over other aspects or designs, nor are they meant to preclude equivalent structures and techniques known to those of ordinary skill in the art. Furthermore, it is to be appreciated that the various drawings are not drawn to scale from one figure to another nor inside a given figure, and in particular that the size of the components are arbitrarily drawn for facilitating the reading of the drawings.

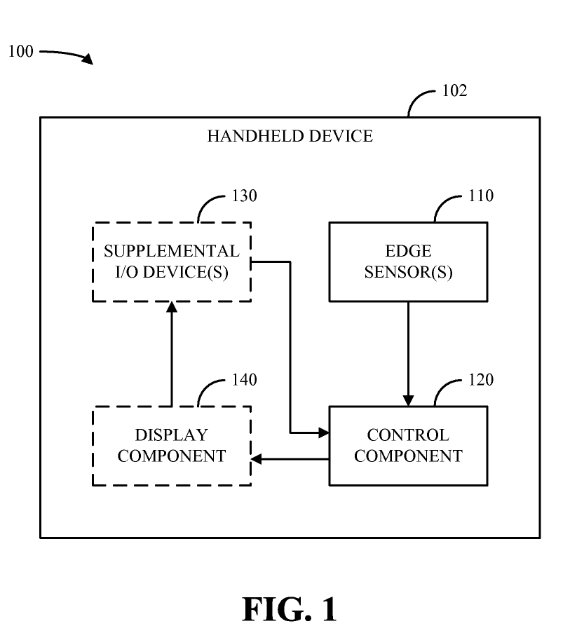

Referring now to the drawings, FIG. 1 illustrates a block diagram of a system 100 for controlling a handheld device 102 in accordance with various aspects described herein. It can be appreciated that handheld device 102 illustrated by FIG. 1 can be any suitable device, such as portable and/or non-portable electronic devices or the like. Examples of handheld devices 102 that can be utilized include, but are not limited to, mobile telephone handsets, electronic game systems and/or game controllers, musical instruments, Global Positioning System (GPS) receivers, Personal Digital Assistants (PDAs), smartphones, package tracking devices, laptop and/or tablet computers, virtual reality systems, and/or any other appropriate type of device.

In accordance with one aspect, handheld device 102 can be capable of executing one or more sophisticated applications and/or features to provide a rich, interactive user experience. To this end, handheld device 102 can include large display areas, sophisticated processing equipment, and the like. However, it can be appreciated that a large amount of device area is required for the implementation of such components, which in turn reduces the amount of available space on the device 102 for fixed mechanical buttons and controls. Further, it can be appreciated that where space for mechanical controls does exist on a handheld device 102, restrictions in form factor often cause such controls to lack sufficient flexibility and granularity to suit various hand sizes and positions and/or to support complex applications.

Previous approaches, such as touch-screens, have been utilized in the art for providing input to size-constrained devices in an attempt to compensate for the shortcomings of mechanical controls. However, it can be appreciated that there are similarly a number of drawbacks to the implementation of touch-screens and other similar input mechanisms. For example, because a touch-screen serves both as an input device and a display device, a touch-screen often utilizes a large amount of power for lighting, which as a consequence can significantly limit device battery life. Further, due to the fact that a touch-screen serves both as an input device and a display device, it can be appreciated that manipulation of a touch-screen for input purposes often blocks the display provided by the touch-screen, thereby obstructing the user's view of the applications and/or device features for which the touch-screen is being manipulated. In addition, touch-screens, like the mechanical controls they are often employed to replace, are generally themselves not oriented in the most natural or convenient positions for the users manipulating them or for the applications that utilize them.

Accordingly, in one aspect, a handheld device 102 can include one or more edge sensors 110 to provide improved input functionality by facilitating additional control options in a limited amount of space provided at the device 102. For example, edge sensor(s) 110 can be applied to one or more side and/or back edges of a device, thereby allowing inputs normally associated with a touch-screen and/or a mechanical button, dial, or other control to be implemented using the sides of the device 102. As a result, input functions conventionally executed by controls at the front of a device can be moved to traditionally unused space at the sides and/or back of the device, which in turn can facilitate the use of larger device display areas at the front of the device and entry of user input without obstructing the display area (e.g., by engaging a touch-screen). In addition, it can be appreciated that edge sensors 110 can provide input functionality similar to that achieved by conventional mechanisms such as touch-screens without the power requirements ordinarily associated with such mechanisms.

In accordance with one aspect, edge sensors 110 can utilize capacitive, resistive, touch-sensitive, and/or any other suitable sensing technology to detect the presence and/or motion of a user's fingers and/or hands with respect to the edges of an associated device 102. For example, edge sensors 110 can be utilized to monitor the presence or absence of skin contact at various points along the edges of a handheld device. Further, when presence of skin contact is detected, various parameters of various contact points, such as the location, width, spacing, count, pressure, and/or movement of the contact points, can be utilized by the edge sensors 110 to infer the presence and location of a user's hands and/or fingers along the edges of the device 102. In one example, this information can be provided to a control component 120, which can facilitate the control of one or more features and/or applications executed by the device 102. For example, the control component 120 can facilitate a mapping of various points along edge sensor(s) 110 to respective soft keys, which can be manipulated by a user to control operation of the device 102.

In accordance with another aspect, inputs provided by edge sensor(s) 110 can be utilized by the control component 120 in combination with one or more optional supplemental input/output (I/O) device 130, such as a keyboard, numeric keypad, touch-screen, trackball, keyboard, mouse, etc., to provide input for one or more applications and/or features of the device 102. In another example, the control component 120 can manage an optional display component 140 to provide visual information relating to one or more applications and/or features of a handheld device 102 being executed by a user.

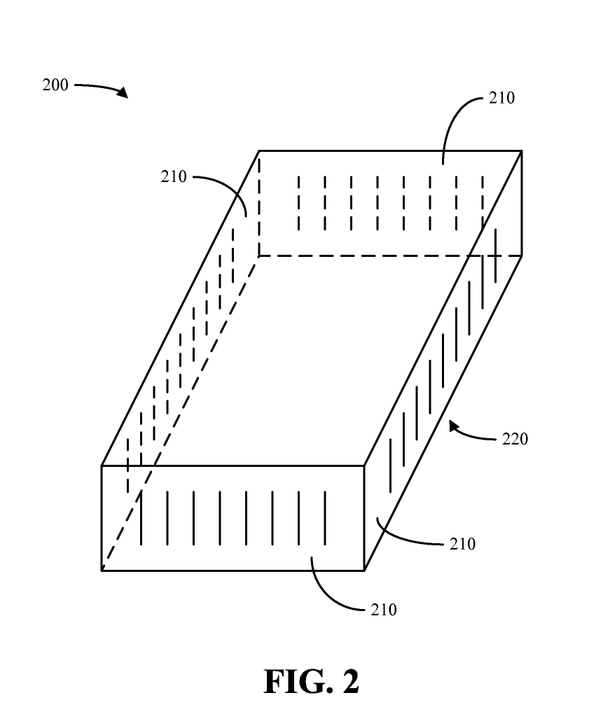

Turning now to FIG. 2, a diagram 200 is provided that illustrates an example sensor implementation for an electronic device (e.g., handheld device 102) in accordance with various aspects. In one example, a device as illustrated by diagram 200 can be provided, to which one or more edge sensors 210 can be affixed and/or otherwise placed at the side edges of the device. Additionally and/or alternatively, a back sensor 220 can be placed at the back edge of the device.

In accordance with one aspect, side sensors 210 and/or a back sensor 220 can be faceted, such that a plurality of touch points are provided along the length of each sensor 210 and/or 220. As illustrated in diagram 200, touch points at side sensors 210 are divided by vertical lines along each sensor 210. Additionally and/or alternatively, it can be appreciated that touch points could also be implemented across the width of the sensors 210 and/or 220, thereby creating a two-dimensional array of touch points across each sensor 210 and/or 220.

In accordance with another aspect, edge sensors 210 and/or back sensor 220 can be implemented using any suitable sensing technology or combination of technologies, such as capacitive sensing, resistive sensing, touch or pressure sensing, and/or any other suitable sensing technology that can be placed along the edges of an associated device as illustrated by diagram 200. While various example implementations are described herein in the context of capacitive sensing, it should be appreciated that capacitive sensing is only one implementation that can be utilized and that, unless explicitly stated otherwise in the claims, the claimed subject matter is not intended to be limited to such an implementation.

As illustrated by diagram 200, sensors 210 and 220 can be placed along the side and back edges of an associated device, respectively, in order to allow the sides and/or back of an electronic device to be utilized for providing input to the device. Accordingly, it can be appreciated that the sensor implementation illustrated by diagram 200 can facilitate user input without requiring a user to obstruct a display area located at the front of a device to enter such input, in contrast to conventional input mechanisms such as touch-screens or mechanical controls located at the front of a device. Further, side sensor(s) 210 and/or back sensor 220 can additionally be utilized to detect and monitor a plurality of contacts simultaneously, thereby facilitating a rich, intuitive user input experience that is similar to that associated with multi-touch touch-screens and other similar input mechanisms without incurring the cost traditionally associated with such input mechanisms. Moreover, due to the rich, intuitive user input experience provided by sensors 210 and/or 220, various applications can be enabled at an associated device that would otherwise be impractical for a handheld device.

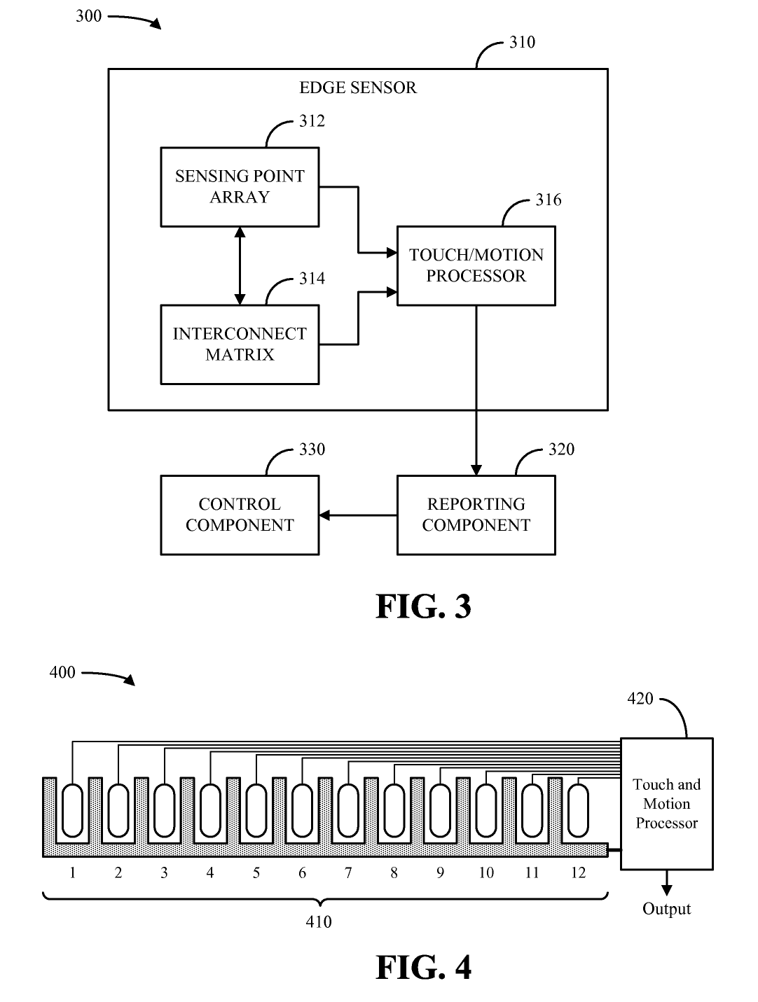

Referring now to FIG. 3, a system 300 for controlling a handheld device in accordance with various aspects is illustrated. In one example, system 300 can include an edge sensor 310, which can be applied to one or more outer edges of an associated device as generally described herein. In accordance with one aspect, edge sensor 310 can include one or more sensing points arranged in a linear array 312 and an interconnection matrix 314 that joins the sensing points in the array 312.

In one example, edge sensor 310 can be segmented as illustrated by diagram 200 such that various sensing points in the sensing point array 312 correspond to respective locations along the edge sensor 310. Accordingly, the sensing point array 312 and/or interconnection matrix 314 can be monitored by a touch and motion processor 316 that detects and reports the presence or absence of skin contact (e.g., from a user's hands and/or fingers) at various points along the edge sensor 310 based on changes in capacitance, resistance, pressure, or the like observed at the sensing points. In accordance with one example, a reporting component 320 can be utilized to report information obtained by the touch and motion processor 316 to a control component 330, which can in turn utilize the information as input for one or more applications.

In one example, touch and motion processor 316 can monitor relationships between adjacent sensing points, the grouping of contacts, separation of contact points, a number of detected contact points, and/or other similar observations to detect the presence and/or positioning of the hands and/or fingers of a user relative to the edge sensor 310. Techniques by which the touch and motion processor 316 can perform such monitoring and detection are described in further detail infra.

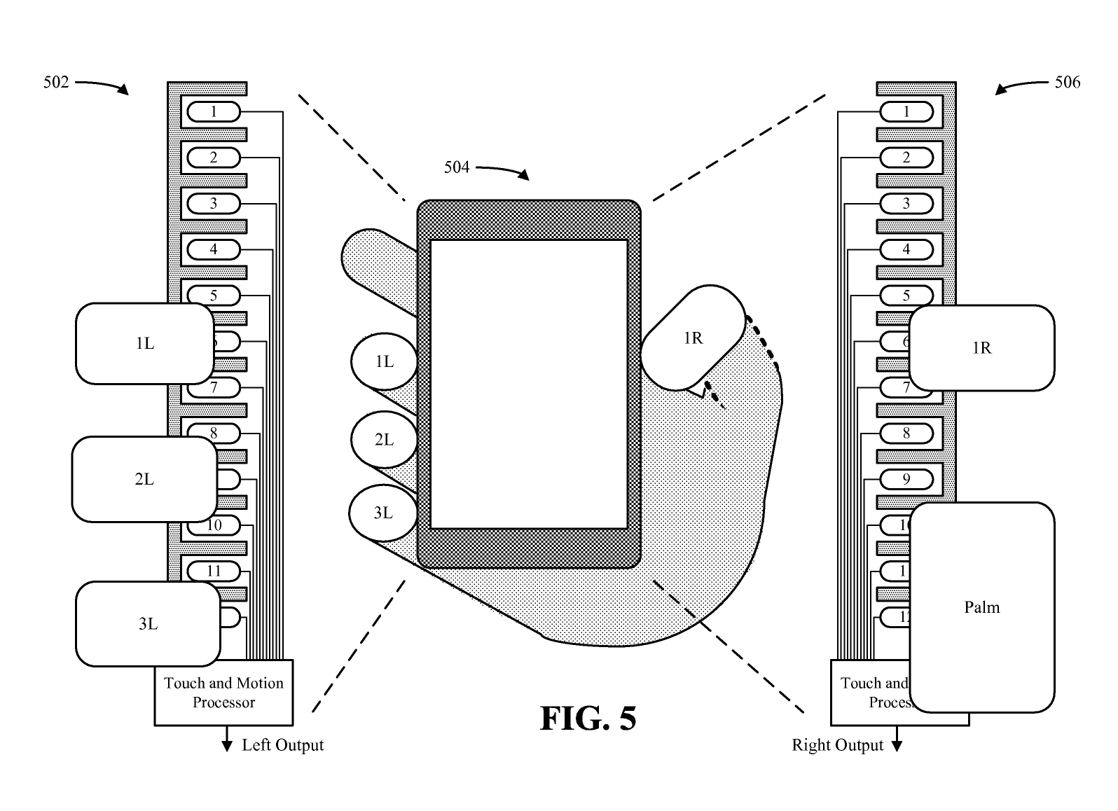

Turning to FIG. 4, a diagram 400 is provided that illustrates an example edge sensor that can be implemented in accordance with various aspects described herein. As diagram 400 illustrates, an edge sensor can include an array of sensing points 410, which can be joined by an interconnection matrix and/or coupled to a touch and motion processor 420. In accordance with one aspect, sensing points 410 can utilize changes in capacitance, resistance, pressure, and/or any other suitable property or combination of properties to sense the presence or absence of skin contact with the sensing points 410. Diagram 400 illustrates an array of 12 sensing points 410 for purposes of clarity of illustration; however, it should be appreciated that any number of sensing points 410 can be utilized in conjunction with an edge sensor as described herein.

In one example, the touch and motion processor 420 can utilize information obtained from one or more sensing points 410 and/or a related interconnection matrix to measure and report edge contact presence, location, width, spacing, count, pressure, movement, and/or any other suitable property on a periodic basis (e.g., via a reporting component 320). These reports can subsequently be used by various applications at an associated device (e.g., via a control component 330) that are configured to utilize control inputs from a device edge associated with the sensor illustrated by diagram 400. For example, one or more applications can utilize information reported from the touch and motion processor 420 to control soft keys that are mapped to respective portions of the sensing points 410, as described in further detail infra.

By way of specific, non-limiting example, the sensing points 410 can utilize capacitive sensing such that respective sensing points 410 exhibit a capacitance when in contact with human skin (e.g., from a user's hand and/or fingers). Based on these capacitances and changes thereto, the touch and motion processor 420 can determine relationships between adjacent sensing points 410, grouping between contacts, separation between contact points, the number of detected contacts, and/or other appropriate factors for determining the presence, location, and/or movement of the hands and/or fingers of a user with respect to the sensor.

An example application of the edge sensor illustrated by diagram 400 is provided in FIG. 5. In accordance with one aspect, FIG. 5 illustrates an example portable device having edge sensors along the left and right edges of the device. More particularly, diagram 504 illustrates a front view of the device, while diagrams 502 and 506 respectively provide detailed illustrations of the left and right edge sensors employed on the device. While detail view diagrams 502 and 506 illustrate respective edge sensors having 12 touch points, it should be appreciated that any suitable number of touch points can be utilized and that respective sensors utilized with a common device can have uniform and/or non-uniform numbers of associated touch points. Further, it should be appreciated that while a generic electronic device is illustrated in diagram 504 for simplicity, the implementations illustrated by FIG. 5 could be utilized for any suitable electronic device, such as, for example, a mobile telephone handset, an electronic game system and/or game controller, a musical instrument (e.g., an electronic keyboard, guitar, etc.), a GPS receiver, a PDA, a smartphone, a package tracking device (e.g., a barcode scanner), a computer (e.g., a desktop, laptop, and/or tablet computer), a virtual reality device, and/or any other appropriate type of device.

As the front view diagram 504 illustrates, a user can hold the portable device with his right hand, such that the thumb, denoted as 1R, and palm of the user rest against the right side of the device while three fingers of the user, denoted as 1L-3L, rest against the left side of the device. Accordingly, as shown in left detail view diagram 502, the three fingers of the user resting against the left side of the device can contact sensing points on the left sensor implemented on the device, which can in turn cause a change in the properties of the contacted sensing points. Based on these changes in properties, a touch and motion processor for the left edge sensor can determine the number, spacing, width, and/or other properties of each contact, from which it can infer that the user has rested his fingers against the left side of the device. In one example, information relating to user contact with the left edge sensor can be relayed as left sensor output to one or more other components of the device to be utilized as input and/or for further processing.

Similarly, as illustrated by right side detail view diagram 506, a touch and motion processor for the right edge sensor can detect changes in the properties of sensing points at which the user's thumb and/or palm have contacted the right edge of the device. Based on these detected changes, the touch and motion processor for the right edge sensor can determine information relating to user contact with the right edge sensor and relay this information as output for input to one or more applications and/or for further processing.

While the left and right edge sensors are illustrated in FIG. 5 as having separate touch and motion processors, it should be appreciated that one or more sensors associated with an electronic device can share a common touch and motion processor. Further, it should be appreciated that the functionality of the touch and motion processor(s) as illustrated by FIG. 5 could also be implemented using any other suitable component(s) of an associated device, such as one or more generalized processing units provided for an electronic device. In a common processor implementation, it can additionally be appreciated that separate outputs can be provided for each sensor monitored by a processor, or alternatively outputs from a plurality of sensors can be combined into a common output.

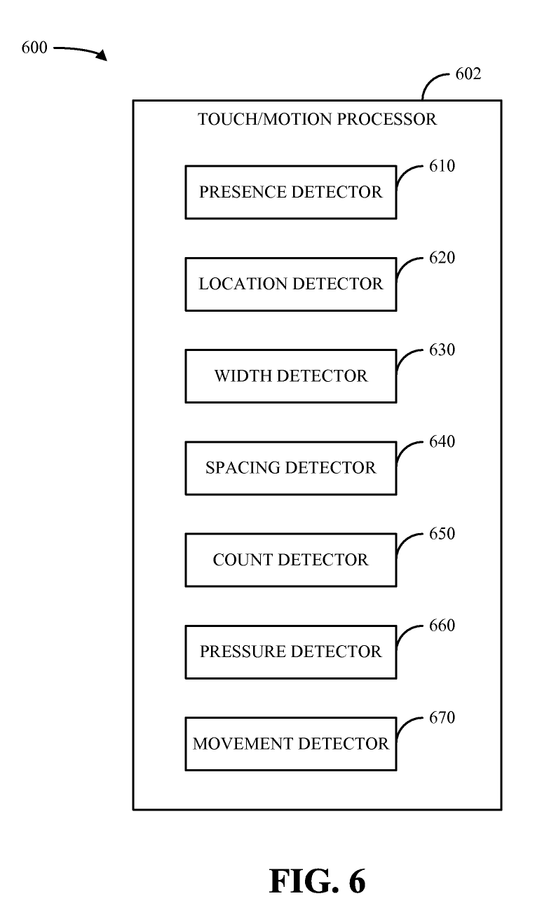

Referring now to FIG. 6, a block diagram of a system 600 for processing sensor contacts in accordance with various aspects is illustrated. In one example, system 600 can include a touch/motion processor 602 associated with a sensor applied to an electronic device. In accordance with one aspect, touch/motion processor 602 can include one or more detectors 610-670 for respectively detecting presence, location, width, spacing, count, pressure, and/or movement of touch points between an associated device edge and a user's hand. It can be appreciated that detectors 610-670 are provided by way of example and that, in various implementations, a touch/motion processor can implement fewer than the detectors 610-670 illustrated in FIG. 6 and/or one or more detectors not illustrated in FIG. 6.

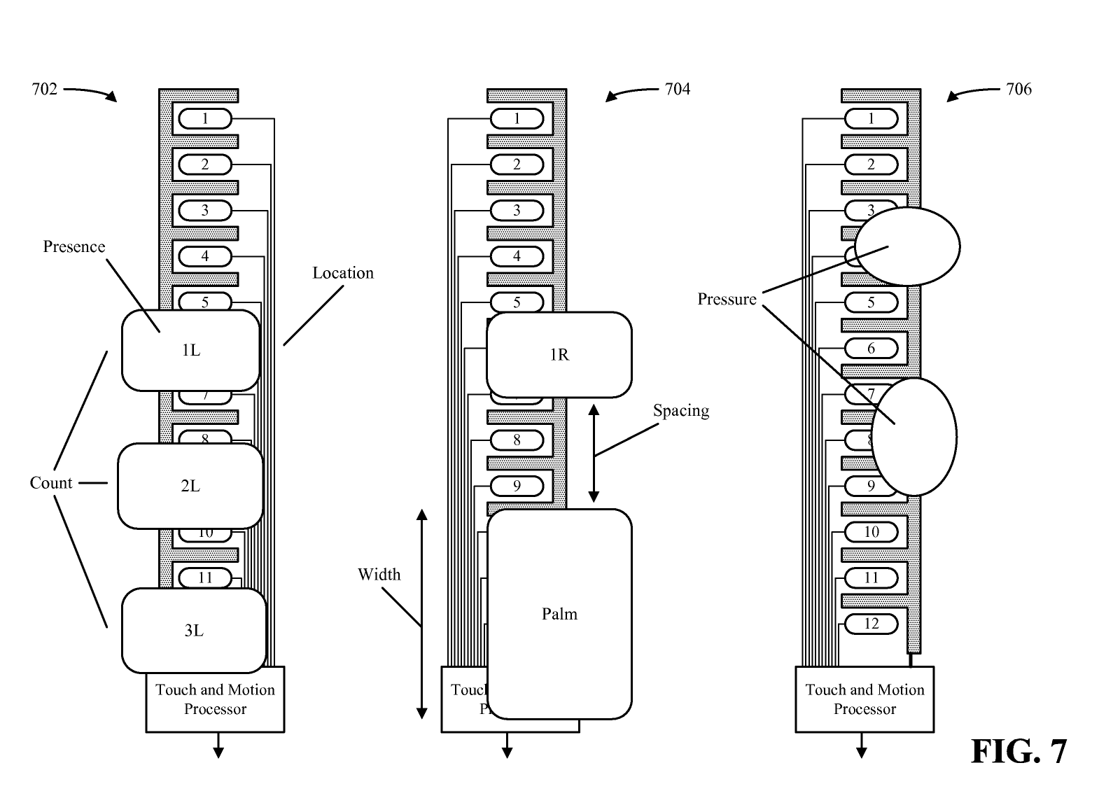

In accordance with various aspects, detectors 610-670 can operate as follows. In accordance with one aspect, presence detector 610 can detect the presence or absence of contacts between a user's hand and/or fingers and an associated edge sensor, as illustrated by diagram 702 in FIG. 7. In one example, if a given sensing point on an associated sensor exhibits a change in capacitance (or another suitable property), presence detector 610 can determine that there is contact on some point along the perimeter of the device corresponding to the sensor. In another example, contact detected by presence detector, or lack thereof, can be utilized by touch/motion processor 602 that the device is either in or out of a user's hand.

In accordance with another aspect, location detector 620 can be utilized to determine the location of one or more contacts on an associated sensor as illustrated by diagram 702 in FIG. 7. In one example, respective sensing points on an associated sensor can be numbered and have respective known locations along the sensing point array. Accordingly, when a specific sensing point exhibits a change in capacitance and/or another suitable property, location detector 620 can be utilized to determine the location of contact.

Width detector 630 can be utilized to determine the width of a contact with an associated edge sensor as illustrated by diagram 704 in FIG. 7. In one example, a substantially large number of sensing points can be provided on a sensor and spaced closely together such that a finger or palm spans multiple sensing points. Accordingly, width detector 630 can attempt to identify consecutive strings of contacted sensing points, based on which contact width can be determined. In accordance with one aspect, contact width as determined by width detector 630 can be utilized to determine whether contact was made by, for example, a finger, a palm, or a thumb of the user. In one example, width detector 630 can define the center of a contact as the middle point between the distant ends of the contacted sensing point string.

In accordance with another aspect, spacing detector 640 can be utilized to determine the spacing between multiple detected contacts, as illustrated by diagram 704 in FIG. 7. In one example, spacing detector 640 can determine spacing between contacts by identifying non-contacted sensing points that span gaps between contacted sensing points. Accordingly, it can be appreciated that small strings of non-contacted sensing points can indicate close spacing, while long strings of non-contacted sensing points can indicate distant spacing. This information can be used by touch/motion processor 602 to, for example, ascertain the relationship between contact points to determine the presence of a thumb and palm versus adjacent fingers.

In accordance with a further aspect, count detector 650 can be utilized to detect the number of distinct contacts made with an associated sensor, as illustrated by diagram 702 in FIG. 7. In one example, count detector 650 can regard respective consecutive strings of adjacent contacted sensing points as indicating an object (e.g., finger, thumb, palm, etc.) touching the associated device edge. Accordingly, count detector 650 can utilize this information to ascertain the number of objects touching one or more edges of the device.

Pressure detector 660 can be utilized to detect respective pressures of contacts to an associated sensor. In accordance with one aspect, pressure detector 660 can utilize variance in one or more properties of fingers and/or other objects contacting the sensor with pressure as illustrated by diagram 706 in FIG. 7. For example, it can be observed that fingers, palms, and the like tend to spread (e.g., creating more linear contact) as additional pressure is applied. Thus, in the example illustrated by diagram 706 in FIG. 7, a relatively light amount of pressure has been applied to the top-most contact point while heavier pressure has been applied to the lower contact point. As a result, it can be appreciated that an object influences more sensing points when pressed firmly versus lightly. Accordingly, pressure detector 660 can utilize this information to determine changes in applied pressure at one or more contact points. In one example, pressure detector 660 can measure relative changes in pressure and/or absolute pressure values at one or more contact points. In another example, the operation of pressure detector 660 can be normalized on a per-user basis in order to allow pressure detector 660 to adapt to the size, shape, and/or other properties of the hands and/or fingers of a particular user.

In accordance with another aspect, movement detector 670 can be utilized to detect movement of one or more contacts along an associated sensor. In one example, consecutive strings of contacted sensing points corresponding to a contact point can shift up and down if the object (e.g., finger, thumb, palm, etc.) making the contact is moved along the length of the sensor. Accordingly, movement detector 670 can use this information to ascertain movement of any object touching the device edge.

In one example, touch/motion processor 602 can report measurements from detectors 610-670 on a periodic basis. These reports can subsequently be utilized by, for example, various applications that are dependent on control inputs from the edge of an associated device in order to facilitate control of such applications.

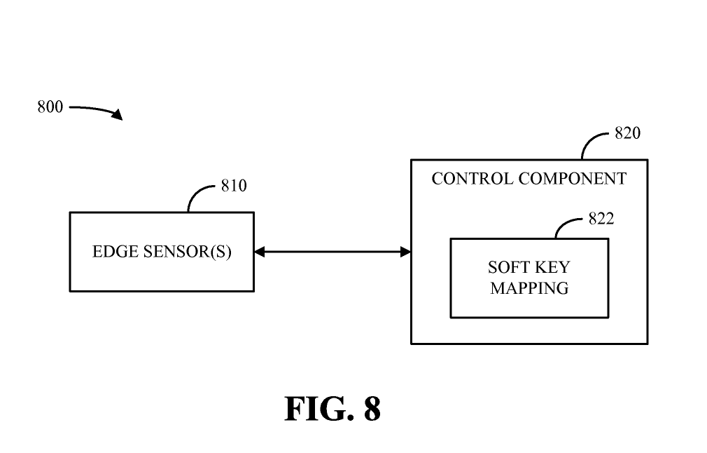

Turning to FIG. 8, a system 800 for associating a soft key mapping 822 with one or more edge sensors 810 in accordance with various aspects is illustrated. As system 800 illustrates, one or more edge sensors 810 can be utilized in combination with a control component 820 to enable a user to provide input to an associated electronic device. In one example, control component 820 can employ a soft key mapping 822 that can map various portions of the edge sensor(s) 810 to respective control regions, thereby allowing contacts and/or movement relative to mapped portions of the edge sensor(s) 810 to be interpreted as user inputs. For example, soft key mapping 822 can include one or more “button” assignments that facilitate processing a contact with a given portion of edge sensor(s) 810 as equivalent to pressing a hardware button. As another example, soft key mapping 822 can include one or more “slider” assignments that facilitate processing movement of a contact point with a given portion of edge sensor(s) as equivalent to movement of a physical slider, dial, or the like.

In accordance with one aspect, a soft key mapping 822 can be made adaptive to the manner in which a particular user holds an associated device. For example, control regions provided by soft key mapping 822 can be moved between sensors 810 and/or along a sensor 810 based on the detected positions of a user's fingers. In another example, a soft key mapping 822 can be utilized to enable an associated device to be accommodating to a user with a physical disability such as missing fingers. For example, by determining the positioning of a user's palm and/or fingers along the edges of a device based on the width, spacing, or other properties of the user's contact points with the device, information regarding the physical ability of the user can be inferred. Based on this information, the soft key mapping 822 can be adjusted to best accommodate the user's ability and to allow a user that is physically unable to utilize traditional mechanical controls such as keypads, dials, or the like to provide input to an associated device. For example, if it is determined that a user has difficulty reaching one or more portions of a device while holding the device in his hand, the soft key mapping 822 can be adjusted to avoid placing control regions at those portions.

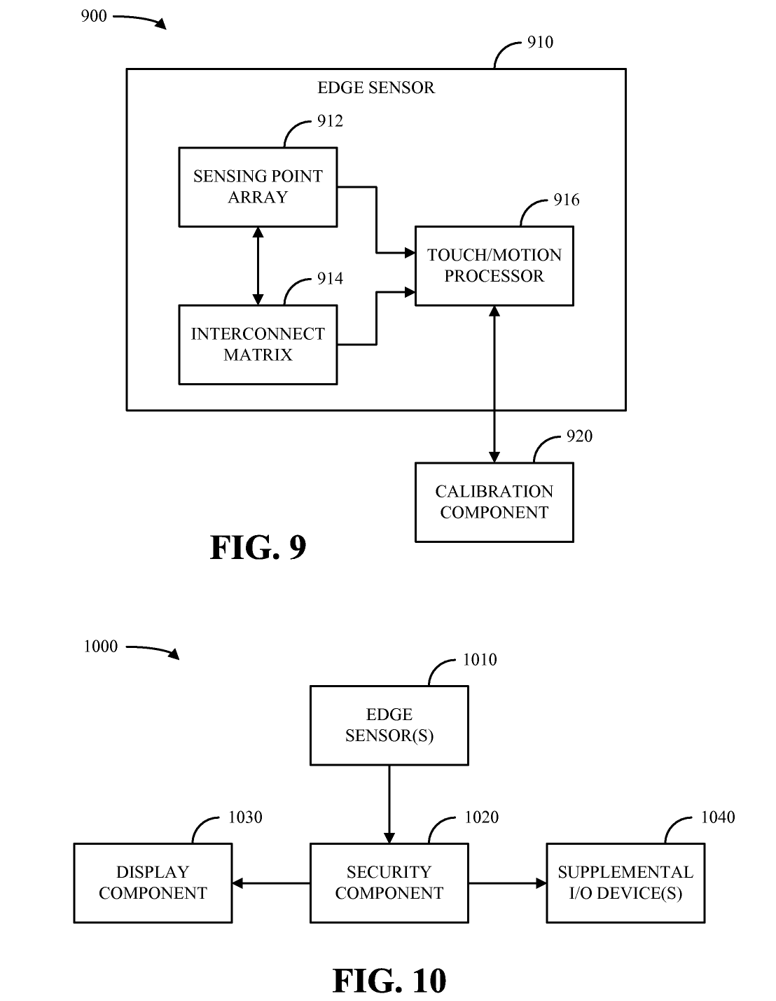

Referring to FIG. 9, illustrated is a system 900 for sensor calibration in accordance with various aspects. In one example, system 900 can include an edge sensor 910, which can comprise a sensing point array 912, an interconnection matrix 914, and a touch and motion processor 916 that can function in a similar manner to the edge sensor 310 and components thereof illustrated by FIG. 3. In accordance with one aspect, system 900 can further include a calibration component 900, which can facilitate adjustment of the touch and motion processor 916 at edge sensor 910 in order to enable the edge sensor 910 to provide more natural and accurate input for a particular user of a device associated with the edge sensor 910.

In one example, the calibration component 920 can facilitate adjustment of the touch and motion processor 916 by guiding a user of an associated device through a calibration process. For example, upon using a device for the first time, a user can be prompted by the calibration component 920 to touch various points on one or more edges of the device with his left hand and/or right hand in order to allow the calibration component 920 to learn about the characteristics of the user's fingers. As an example, the calibration component 920 can prompt a user to place the device in one hand and to place the fingers of his holding hand against the edge of the device at varying heights. As another example, the calibration component 920 can prompt the user to simulate one or more use scenarios for the device. For example, the user can be asked to place the device in his left hand as if he is making a phone call with the device, to place the device in his right hand as if he is typing a text message, or the like. Additionally and/or alternatively, the calibration component 920 can prompt a user to touch various points along the edge sensor 910 with varying degrees of pressure in order to obtain information relating to the manner in which the shapes of contact points made by the user's fingers vary under different pressure conditions.

In accordance with one aspect, the calibration component 920 can be utilized for multiple users that utilize an associated device. In one example, the calibration component 920 can maintain separate profiles for each user of a device, such that each user can individually perform a calibration procedure and/or adjust the performance of the device to his or her own individual settings. In another example, the calibration component 920 can additionally maintain a default profile for new and/or temporary users of a device. The default profile can, for example, leverage various general characteristics of the human hand in order to maximize accuracy and comfort for a substantially large portion of the device's target user population.

By way of specific example, calibration component 920 can be utilized in combination with an edge sensor 910 to provide a high degree of granularity in pressure, motion, or the like, for applications such as electronic musical instruments and/or other applications that require a high degree of sensing accuracy. For example, one or more edge sensors 910 can be configured to act in a similar manner to guitar strings and/or a guitar fret board, such that a user can contact the edge sensors 910 to produce music in a similar manner to a conventional guitar. In such an example, the calibration component 920 can be utilized to adjust the edge sensors 910 based on the size of a user's hands, a user's hand motion tendencies, etc., to enable the user to customize the operation of the device in a similar manner to a conventional musical instrument.

In another example, calibration component 920 can additionally allow a user of an associated device to manually provide information that can be utilized in adjusting the edge sensor 910 in addition to or in place of automatic calibration data. For example, in the case described above wherein a user has a physical disability, the user can provide information relating to his physical ability to the calibration component 920 in order to permit the operation of the edge sensor 910 to be better tailored to his abilities.

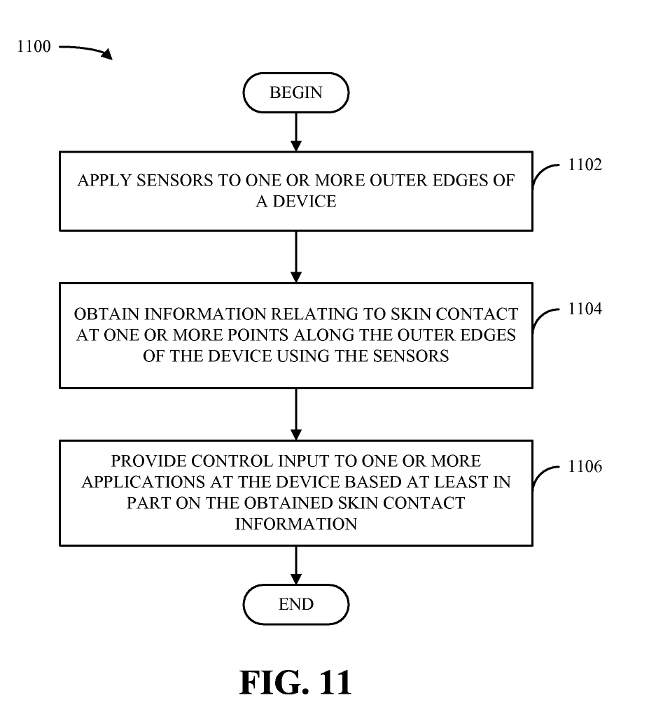

Referring now to FIG. 10, a block diagram 1000 is provided that illustrates a system 1000 for securing a portable device in accordance with various aspects described herein. In accordance with one aspect, system 1000 can include one or more edge sensors 1010 that can be utilized to provide input to an associated electronic device as described herein. In addition, system 1000 can include a security component that can leverage the input functionality of the edge sensor(s) 1010 to secure the associated device against unauthorized use. In one example, security component 1020 can be utilized to secure a display provided by a display component 1030, the use of one or more supplemental I/O devices 1040, and/or any other application and/or feature associated with the device.

In accordance with one aspect, the security component 1020 can function by prompting a user to provide a combination of inputs using edge sensor(s) 1010 (and/or one or more supplemental I/O devices 1040). Subsequently, when one or more secured features of an associated device are accessed, the security component 1020 can determine a combination of inputs provided at edge sensor(s) 1010 and/or supplemental I/O device(s) 1040 (e.g., with or without prompting). Access to the secured feature(s) can then be conditioned by the security component 1020 on a successful match between the original combination of inputs and the combination of inputs detected at the time of access. Accordingly, it can be appreciated that the security component 1020 can regard a combination of inputs at edge sensor(s) 1010 as a passcode-like security mechanism for accessing various features of an associated device.

The combination of inputs provided at edge sensor(s) 1010 can correspond to, for example, a manner of holding an associated device, such that the security component 1020 can learn about the nature of a user's hand. For example, upon prompting, during the first time a user accesses a particular secured device feature, during calibration of a device (e.g., as illustrated by system 900), and/or at any other suitable time, the security component 1020 can obtain information about the hand characteristics and/or the holding style of a user of the device. Subsequently, when a secured feature of the device is requested, the security component 1020 can determine whether inputs provided to the edge sensor(s) 1010 match the characteristics of the user's hand. If the inputs do not match the user characteristics, the security component 1020 can infer that a different user is utilizing the device. As a result, the security component 1020 can facilitate reconfiguration of the device or creation of a new device profile for the new user, deny access to the requested feature, and/or perform any other appropriate actions.

Alternatively, the combination of inputs at edge sensor(s) can correspond to an arbitrary combination of touch inputs at edge sensor(s) 1010 provided by the user, and/or any other appropriate combination of inputs provided by the user. By way of specific example, a user can create a combination of sensor inputs by contacting the middle of an edge sensor 1010 on one side of a device and the upper and lower edges of an edge sensor 1010 on the opposite side of the device. In accordance with one aspect, security component 1020 can facilitate the use of a variety of security measures for an associated device. For example, different input combinations with respect to edge sensor(s) 1010 can be utilized for respective features of the device. As another example, security component 1020 can utilize conventional security measures, such as numeric passwords or fingerprint readings, in combination with and/or in place of edge sensor input combinations for some device features. Thus, it can be appreciated that features of a device can have different levels of security and/or require different types of authentication.

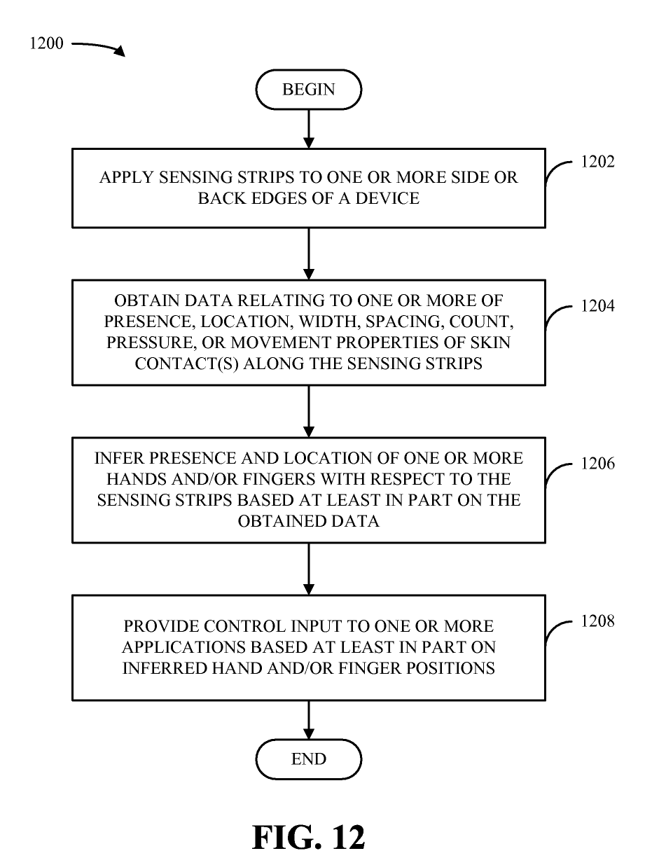

Turning to FIGS. 11-14, methodologies that may be implemented in accordance with various aspects described herein are illustrated via respective series of acts. It is to be appreciated that the methodologies claimed herein are not limited by the order of acts, as some acts may occur in different orders, or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as claimed herein.

Referring to FIG. 11, a method 1100 for controlling an electronic device (e.g., device 102) is illustrated. At 1102, sensors (e.g., edge sensors 110) are applied to one or more outer edges of a device. At 1104, information relating to skin contact at one or more points along the outer edges of the device is obtained using the sensors. At 1106, control input is provided to one or more applications at the device (e.g., by a control component 120) based at least in part on the skin contact information obtained at 1104.

FIG. 12 illustrates another method 1200 of controlling an electronic device. At 1202, sensing strips (e.g., sensors 210 and/or 220) are applied to one or more side or back edges of a device. At 1204, data relating to one or more of presence, location, width, spacing, count, pressure, or movement properties of skin contact(s) along the sensing strips are obtained (e.g., using detectors 610-670). At 1206, presence and location of one or more hands and/or fingers with respect to the sensing strips are inferred based at least in part on the data obtained at 1204. At 1208, control input is provided to one or more applications based at least in part on the hand and/or finger positions inferred at 1206.

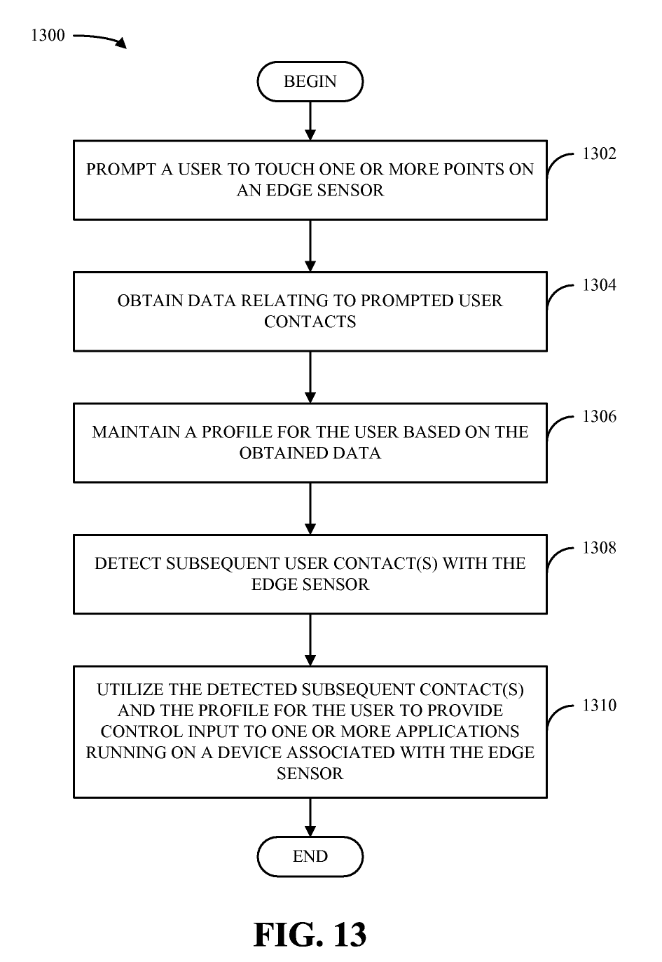

Referring now to FIG. 13, a flowchart is provided that illustrates a method 1300 of calibrating a touch sensing system. At 1302, a user is prompted to touch one or more points on an edge sensor (e.g., edge sensor 910). At 1304, data relating to the prompted user contacts are obtained. At 1306, a profile is maintained for the user (e.g., by a calibration component 920) based on the data obtained at 1304. At 1308, subsequent user contact(s) with the edge sensor is detected. At 1310, the subsequent contact(s) detected at 1308 and the profile for the user maintained at 1306 are utilized to provide control input to one or more applications running on a device associated with the edge sensor.

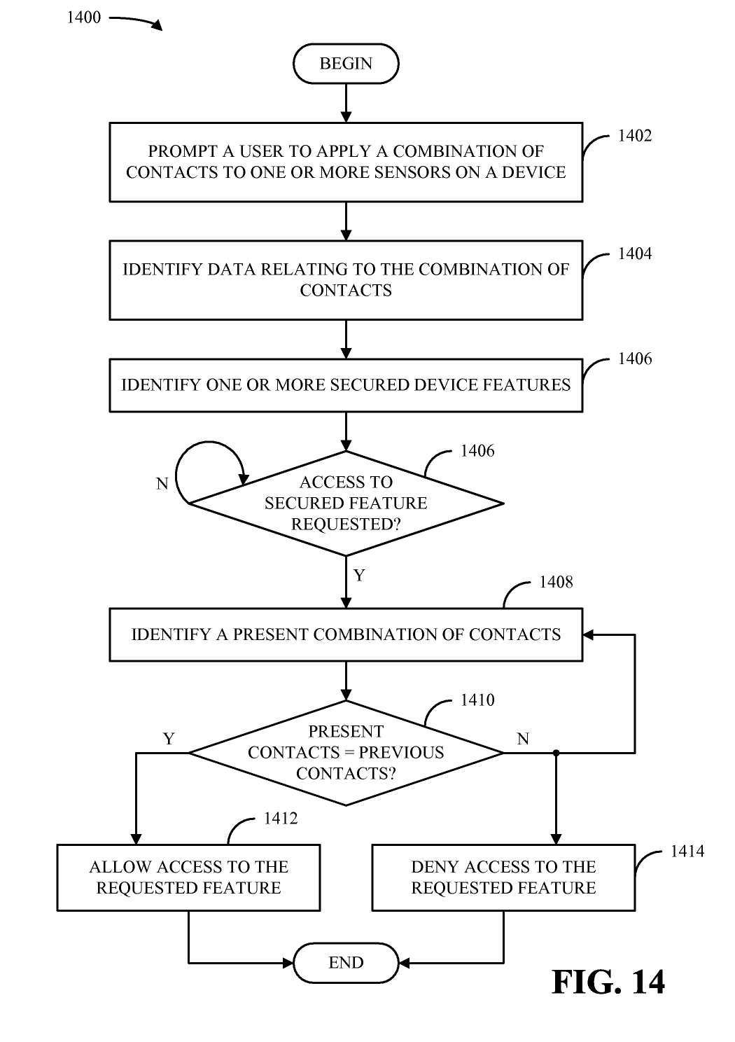

Turning to FIG. 14, a method 1400 for utilizing an edge sensor to secure a handheld electronic device is illustrated. At 1402, a user is prompted (e.g., by a security component 1020) to apply a combination of contacts to one or more sensors (e.g., edge sensor(s) 1010) on a device. At 1404, data relating to the combination of contacts (as prompted at 1402) are identified. At 1406, one or more secured device features (e.g., associated with a display component 1030 and/or a supplemental I/O device 1040) are identified.

Next, at 1406, it is determined whether access to a secured feature identified at 1406 is requested. If access to a secured feature is not requested, the determination at 1406 is repeated. Otherwise, method 1400 continues to 1408, wherein a present combination of contacts is identified (e.g., by prompting a user for new contacts or by determining contacts without prompting). At 1410, it is then determined whether the present contacts identified at 1410 match the previous contacts provided at 1404. If the contacts match, method 1400 concludes at 1412, wherein access to the requested feature is allowed. Otherwise, method 1400 can either return to 1408 to obtain new contacts or proceed to 1414 to deny access to the requested feature.

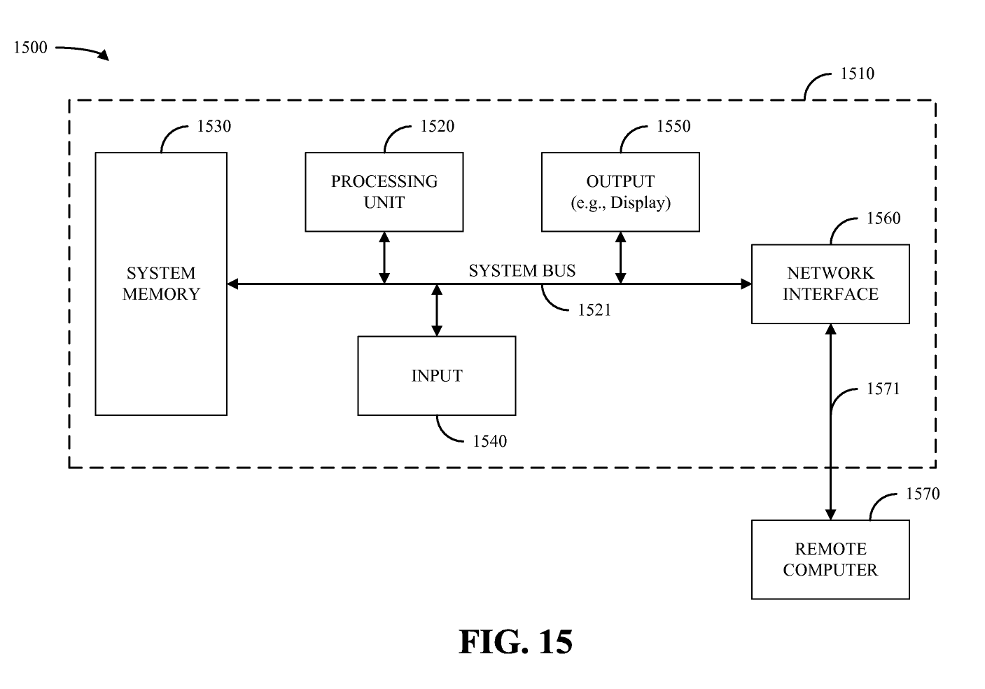

Turning to FIG. 15, an example computing system or operating environment in which various aspects described herein can be implemented is illustrated. One of ordinary skill in the art can appreciate that handheld, portable and other computing devices and computing objects of all kinds are contemplated for use in connection with the claimed subject matter, e.g., anywhere that a network can be desirably configured. Accordingly, the below general purpose computing system described below in FIG. 15 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer executable instructions, such as program modules, being executed by one or more computers, such as client workstations, servers or other devices. Those skilled in the art will appreciate that the claimed subject matter can also be practiced with other computer system configurations and protocols.

FIG. 15 thus illustrates an example of a suitable computing system environment 1500 in which the claimed subject matter can be implemented, although as made clear above, the computing system environment 1500 is only one example of a suitable computing environment for a media device and is not intended to suggest any limitation as to the scope of use or functionality of the claimed subject matter. Further, the computing environment 1500 is not intended to suggest any dependency or requirement relating to the claimed subject matter and any one or combination of components illustrated in the example operating environment 1500.

With reference to FIG. 15, an example of a computing environment 1500 for implementing various aspects described herein includes a general purpose computing device in the form of a computer 1510. Components of computer 1510 can include, but are not limited to, a processing unit 1520, a system memory 1530, and a system bus 1521 that couples various system components including the system memory to the processing unit 1520. The system bus 1521 can be any of several types of bus structures including a memory bus or memory controller, a peripheral bus, and a local bus using any of a variety of bus architectures.

Computer 1510 can include a variety of computer readable media. Computer readable media can be any available media that can be accessed by computer 1510. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510. Communication media can embody computer readable instructions, data structures, program modules or other data in a modulated data signal such as a carrier wave or other transport mechanism and can include any suitable information delivery media.

The system memory 1530 can include computer storage media in the form of volatile and/or nonvolatile memory such as read only memory (ROM) and/or random access memory (RAM). A basic input/output system (BIOS), containing the basic routines that help to transfer information between elements within computer 1510, such as during start-up, can be stored in memory 1530. Memory 1530 can also contain data and/or program modules that are immediately accessible to and/or presently being operated on by processing unit 1520. By way of non-limiting example, memory 1530 can also include an operating system, application programs, other program modules, and program data.

The computer 1510 can also include other removable/non-removable, volatile/nonvolatile computer storage media. For example, computer 1510 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1521 through a non-removable memory interface such as an interface, and a magnetic disk drive or optical disk drive can be connected to the system bus 1521 by a removable memory interface, such as an interface.

A user can enter commands and information into the computer 1510 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1520 through user input 1540 and associated interface(s) that are coupled to the system bus 1521, but can be connected by other interface and bus structures, such as a parallel port, game port or a universal serial bus (USB). A graphics subsystem can also be connected to the system bus 1521. In addition, a monitor or other type of display device can be connected to the system bus 1521 via an interface, such as output interface 1550, which can in turn communicate with video memory. In addition to a monitor, computers can also include other peripheral output devices, such as speakers and/or a printer, which can also be connected through output interface 1550.

The computer 1510 can operate in a networked or distributed environment using logical connections to one or more other remote computers, such as remote computer 1570, which can in turn have media capabilities different from device 1510. The remote computer 1570 can be a personal computer, a server, a router, a network PC, a peer device or other common network node, and/or any other remote media consumption or transmission device, and can include any or all of the elements described above relative to the computer 1510. The logical connections depicted in FIG. 15 include a network 1571, such as a local area network (LAN) or a wide area network (WAN), but can also include other networks/buses. Such networking environments are commonplace in homes, offices, enterprise-wide computer networks, intranets and the Internet.

When used in a LAN networking environment, the computer 1510 is connected to the LAN 1571 through a network interface or adapter. When used in a WAN networking environment, the computer 1510 can include a communications component, such as a modem, or other means for establishing communications over the WAN, such as the Internet. A communications component, such as a modem, which can be internal or external, can be connected to the system bus 1521 via the user input interface at input 1540 and/or other appropriate mechanism. In a networked environment, program modules depicted relative to the computer 1510, or portions thereof, can be stored in a remote memory storage device. It should be appreciated that the network connections shown and described are non-limiting examples and that other means of establishing a communications link between the computers can be used.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates entry of user input for an electronic device, comprising:
one or more sensors affixed to respective side or back edges of the electronic device;
a processor that identifies presence of one or more skin contacts with the one or more sensors and infers presence and location of one or more hands or fingers of a user relative to the one or more sensors; and
a control component that provides input for the electronic device based on respective hand or finger locations relative to the one or more sensors inferred by the processor.

2. The system of claim 1, wherein the one or more sensors comprise at least one of a capacitive sensor, a resistive sensor, or a touch sensor.

3. The system of claim 2, wherein the one or more sensors respectively comprise a linear array of sensing points and an interconnection matrix that joins the sensing points in the linear array of sensing points.

4. The system of claim 1, wherein the processor determines information relating to at least one of location of a detected skin contact relative to the one or more sensors, a count of skin contacts detected at the one or more sensors, spacing of respective skin contacts detected at the one or more sensors, pressure of a detected skin contact at the one or more sensors, or movement of a detected skin contact relative to the one or more sensors and infers presence and location of one or more hands or fingers of a user relative to the one or more sensors based at least in part on the determined information.

5. The system of claim 1, further comprising a calibration component that monitors characteristics of one or more hands or fingers of a user and facilitates adjustment of the processor based on the monitored characteristics.

6. The system of claim 5, wherein the calibration component maintains a plurality of profiles corresponding to monitored characteristics of respective disparate users and facilitates adjustment of the processor based on monitored characteristics provided for a profile corresponding to a present user of the electronic device.

7. The system of claim 5, wherein the calibration component facilitates manual user entry of information corresponding to one or more characteristics monitored by the calibration component corresponding to a user entering the information.

8. The system of claim 1, further comprising a security component that receives a first combination of inputs from a user from the one or more sensors, identifies a request for access to a secured feature of the electronic device, receives a second combination of inputs from the one or more sensors corresponding to the request, and denies the request if the second combination of inputs does not substantially match the first combination of inputs.

9. The system of claim 1, wherein the control component provides input for the electronic device at least in part by mapping respective portions of the one or more sensors to soft keys, obtaining information from the processor relating to skin contact with respective portions of the one or more sensors mapped to soft keys, and providing inputs to the electronic device corresponding to the respective contacted portions of the one or more sensors mapped to soft keys.

10. The system of claim 1, wherein the electronic device is a mobile telephone handset.

11. The system of claim 1, wherein the electronic device is one or more of an electronic game system or an electronic game controller.

12. A method of controlling an electronic device, comprising:
applying sensors to one or more outer edges of the electronic device;
obtaining information relating to user contact at one or more points along the outer edges of the electronic device using the sensors; and
providing control input to one or more applications at the electronic device based on the obtained information.

13. The method of claim 12, wherein the applying comprises applying one or more of a capacitive sensor, a resistive sensor, or a pressure sensor to an outer edge of the electronic device.

14. The method of claim 12, wherein the obtaining comprises:
detecting one or more points at which a user contacts the outer edges of the electronic device using the sensors; and
obtaining information relating to one or more of location, width, spacing, count, pressure, or movement properties of the one or more detected points.

15. The method of claim 14, further comprising inferring presence or location of one or more hands or fingers of a user with respect to the outer edges of the electronic device based at least in part on the obtained information.

16. The method of claim 12, further comprising:
obtaining data relating to a set of user contacts with the outer edges of the electronic device using the sensors; and
determining one or more characteristics of hands or fingers of the user based on the obtained data;
wherein the providing comprises providing control input to one or more applications at the electronic device based at least in part on the one or more determined characteristics.

17. The method of claim 16, wherein:
the obtaining data relating to a set of user contacts comprises obtaining data relating to contacts of a plurality of users with the outer edges of the electronic device;
the determining comprises determining respective characteristics of hands or fingers of the plurality of users; and
the providing further comprises identifying a present user of the electronic device and providing control input to one or more applications at the electronic device based at least in part on one or more determined characteristics for the identified user.

18. The method of claim 12, further comprising:
obtaining data relating to an initial set of user contacts with the outer edges of the electronic device using the sensors;
identifying a secured device feature and a request for access thereto;
obtaining data relating to a subsequent set of user contacts with the outer edges of the device relating to the request for access to the secured device feature using the sensors; and
allowing access to the secured device feature upon determining that the initial set of user contacts matches the subsequent set of user contacts.

19. The method of claim 12, wherein the providing comprises:
mapping respective portions of the one or more sensors to control regions;
mapping input functions to respective control regions;
obtaining information relating to user contact with the outer edges of the electronic device corresponding to one or more portions of the sensors mapped to respective control regions; and
performing one or more input functions mapped to control regions corresponding to points of user contact with the outer edges of the electronic device.

20. A system that facilitates control input for a handheld device, comprising:
means for sensing one or more points of contact between a user and one or more side or back edges of the handheld device;
means for mapping the sensed points of contact to respective input functions for the handheld device; and
means for providing control input to the handheld device at least in part by performing at least a portion of the input functions mapped to the sensed points of contact.
